(19) United States
(12) Patent Application Publication
(10) Pub. No.: US 2022/0244690 A1
(43) Pub. Date: Aug. 4, 2022

(54) SCHEDULE LEARNING FOR PROGRAMMABLE THERMOSTATS

(71) Applicant: Venstar, Inc., Chatsworth, CA (US)

(72) Inventors: Steven Dushane, Granada Hills, CA (US); Mustafa Oransel, Agoura Hills, CA (US)

(73) Assignee: Venstar, Inc., Chatsworth, CA (US)

(21) Appl. No.: 17/589,031

(22) Filed: Jan. 31, 2022

Related U.S. Application Data
(60) Provisional application No. 63/144,790, filed on Feb. 2, 2021.

(51) Int. Cl. G05B 19/042

(52) U.S. Cl. CPC G05B 19/042; G05B 2219/2614

(57) ABSTRACT

A programmable thermostat that automatically learns the users' schedule is contemplated. The programmable thermostat has a Learning Engine which monitors the users' real-time interaction with the thermostat over a course of a week during an initial learning period, and automatically generates a weekday and weekend schedule based on the users' actions. Once the thermostat has determined the users' schedule for the first week of use, the programmable thermostat will continue to monitor the users' actions during a continuing learning period and may alter the schedule as a result of change of usage. In one or more embodiments, the programmable thermostat is configured to make “predictive adjustments” to the set-point by considering the historical seasonal temperature variations, current outdoor temperature, and building thermal efficiency for heating and cooling.

### RELATED APPLICATION INFORMATION

The present application claims priority under 35 U.S.C. Section 119(e) to U.S. Provisional Patent Application Ser. No. 63/144,790 filed Feb. 2, 2021 entitled “SCHEDULE LEARNING FOR PROGRAMMABLE THERMOSTATS” the disclosure of which is incorporated herein by reference in its entirety.

### BACKGROUND OF THE INVENTION

### 1. Field of the Invention

The present invention relates in general to programmable thermostats for controlling air handling systems for heating, ventilation, and cooling. More particularly, the invention is directed to programmable thermostats that can establish a daily programming schedule based on real-time, user entered thermostat settings.

### 2. Description of the Related Art

Many traditional homes and office building use electronic, programmable thermostats which allows users to select temperature set points throughout the day. Such programmable thermostats may offer the advantage of reduced energy consumption as unoccupied homes and building may be automatically set for reduced energy use. However, may programmable thermostats assume a limited number of schedule periods and specific settings to be adjusted ahead of time. Many consumers want the flexibility, automated convenience, and energy saving advantages of an autonomous on-device schedule learning.

Accordingly, a need exists to provide a programmable thermostat which can be programmed based on real-time user-entered thermostat settings.

### SUMMARY OF THE INVENTION

In the first aspect, a method for programming a thermostat based on a history of real-time, user-entered thermostat settings is disclosed. The method comprises controlling a HVAC system, by a thermostat configured to execute a schedule for a current day of the week, the schedule comprising a series of recorded thermostat settings including heating set points, cooling set points, and other thermostat settings as well as corresponding start times for setting the thermostat to the recorded thermostat settings, and receiving a real-time, user-entered thermostat setting for the current day. The method further comprises recording the user-entered thermostat setting for the current day in a ledger for the current day, the ledger for the current day comprising the user-entered thermostat setting for the current day and a corresponding timestamp indicating the time the user-entered thermostat setting was entered into the thermostat, and in response to the user-entered thermostat setting during an initial learning period, modifying the schedule for the current day of the week during the initial learning period by imposing the user-entered thermostat setting and corresponding timestamp for the current day onto the schedule for the current day of the week, the schedule for the current day of the week based on the schedule for the immediately prior day of the week, wherein the schedule for the current day of the week during the initial learning period comprises a weekday schedule and a weekend schedule. The method further comprises in response to the user-entered thermostat setting during the continuing learning period, the continuing learning period occurs subsequent to the completion of the initial learning period, modifying the schedule for the current day of the week during the continuing learning period is based on predetermined rules and a plurality of ledgers of previous days.

Modifying the schedule for the current day of the week during the continuing learning period for the current day comprises (1) comparing the user-entered thermostat setting and corresponding timestamp to the ledger for the day seven days prior to the current day, (2) determining if the user-entered thermostat setting and corresponding timestamp is consistent with an entry in the ledger for the day seven days prior to the current day, and, (3) modifying the schedule for the current day of the week during the continuing learning period to impose the user-entered thermostat setting and corresponding timestamp onto the schedule for the current day.

Modifying the schedule for the current day of the week during the continuing learning period for the current day comprises (1) comparing the user-entered thermostat setting and corresponding timestamp to the ledger for the day one day prior to the current day, (2) determining if the user-entered thermostat setting and corresponding timestamp is consistent with an entry in the ledger for the day one day prior to the current day, and, (3) modifying the schedule for the current day of the week during the continuing learning period to impose the user-entered thermostat setting and corresponding timestamp onto the schedule for the current day and the schedule for the day one day prior to the current day of the week.

In a first preferred embodiment, controlling a thermostat configured to execute a schedule for a current day of the week further comprises providing temporary changes to the thermostat setpoints and start times to provide a period of preconditioning of the environment controlled by the thermostat. Controlling a thermostat configured to execute a schedule for a current day of the week further preferably comprises providing temporary changes to the thermostat setpoints and start times based on one or more of the following: historical seasonal temperature variations, current outdoor temperature, building thermal efficiency for heating and cooling, and equipment performance during different seasons. Controlling a HVAC system, by a thermostat further preferably comprises the thermostat configured to pause execution of the schedule when the thermostat is set to an away state. The thermostat is preferably configured to communicate with one or more sensors, wherein the readings from the one or more sensors are recorded in the ledger for the current day.

In a second aspect, a method for programming a thermostat based on a history of real-time, user-entered thermostat settings is disclosed. The method comprises controlling a HVAC system, by a thermostat configured to execute a schedule for a current day of the week, the schedule comprising a series of recorded thermostat settings and corresponding start times for setting the thermostat to the recorded thermostat settings, receiving a real-time, user-entered thermostat setting for the current day, and recording the user-entered thermostat setting for the current day in a ledger for the current day, the ledger for the current day comprising the user-entered thermostat setting for the current day and a corresponding timestamp indicating the time the user-entered thermostat setting was entered into the thermostat. The method further comprises in response to the user-entered thermostat setting during an initial learning period, modifying the schedule for the current day of the week during the initial learning period by imposing the user-entered thermostat setting and corresponding timestamp for the current day onto the schedule for the current day of the week, the schedule for the current day of the week based on the schedule for the immediately prior day of the week. The method further comprises in response to the user-entered thermostat setting during the continuing learning period, modifying the schedule for the current day of the week during the continuing learning period is based on predetermined rules and a plurality of ledgers of previous days.

In a second preferred embodiment, the continuing learning period occurs subsequent to the completion of the initial learning period. Controlling a HVAC system, by a thermostat further preferably comprises the thermostat configured to pause execution of the schedule when the thermostat is set to an away state. The thermostat is preferably configured to communicate with one or more sensors, wherein the readings from the one or more sensors are recorded in the ledger for the current day. The schedule for the current day of the week during the initial learning period preferably comprises a weekday schedule and a weekend schedule. The initial learning period comprises seven calendar days. Updating the weekend schedule on Sunday during the initial learning period preferably does not update the weekend schedule for Saturday. The schedule for the current day of the week preferably comprises a weekday schedule comprising schedules for the days of the week of Monday, Tuesday, Wednesday, Thursday, and Friday and a weekend schedule comprising schedules for the days of the week for Saturday and Sunday.

Modifying the schedule for the current day of the week during the continuing learning period for the current day comprises (1) comparing the user-entered thermostat setting and corresponding timestamp to the ledger for the day seven days prior to the current day, (2) determining if the user-entered thermostat setting and corresponding timestamp is consistent with an entry in the ledger for the day seven days prior to the current day, and, (3) modifying the schedule for the current day of the week during the continuing learning period to impose the user-entered thermostat setting and corresponding timestamp onto the schedule for the current day.

Modifying the schedule for the current day of the week during the continuing learning period for the current day comprises (1) comparing the user-entered thermostat setting and corresponding timestamp to the ledger for the day one day prior to the current day, (2) determining if the user-entered thermostat setting and corresponding timestamp is consistent with an entry in the ledger for the day one day prior to the current day, and, (3) modifying the schedule for the current day of the week during the continuing learning period to impose the user-entered thermostat setting and corresponding timestamp onto the schedule for the current day and the schedule for the day one day prior to the current day of the week.

In a third aspect, a programmable thermostat is disclosed. The programmable thermostat comprises a processing device, and a non-transitory computer-readable medium communicatively coupled to the processing device. The medium having stored therein processor-readable instructions which, when executed by the processing device, cause processing device to control a HVAC system, by the processing device configured to execute a schedule for a current day of the week, the schedule comprising a series of recorded thermostat settings and corresponding start times for setting the thermostat to the recorded thermostat settings, and receive a real-time, user-entered thermostat setting for the current day. The processor-readable instructions which, when executed by the processing device, further cause processing device to record the user-entered thermostat setting for the current day in a ledger for the current day, the ledger for the current day comprising the user-entered thermostat setting for the current day and a corresponding timestamp indicating the time the user-entered thermostat setting was entered into the thermostat.

The processor-readable instructions which, when executed by the processing device, further cause processing device to, in response to the user-entered thermostat setting during an initial learning period, modify the schedule for the current day of the week during the initial learning period by imposing the user-entered thermostat setting and corresponding timestamp for the current day onto the schedule for the current day of the week, the schedule for the current day of the week based on the schedule for the immediately prior day of the week. The processor-readable instructions which, when executed by the processing device, further cause processing device to in response to the user-entered thermostat setting during the continuing learning period, modify the schedule for the current day of the week during the continuing learning period is based on predetermined rules and a plurality of ledgers of previous days.

In a third preferred embodiment, the processor-readable instructions which, when executed by the processing device, cause processing device to control a HVAC system, further cause the processing device to provide temporary changes to the thermostat setpoints and start times to provide a period of preconditioning of the environment controlled by the thermostat. The processor-readable instructions which, when executed by the processing device, cause processing device to control a HVAC system, preferably further cause the processing device to provide temporary changes to the thermostat setpoints and start times based on one or more of the following: historical seasonal temperature variations, current outdoor temperature, building thermal efficiency for heating and cooling, and equipment performance during different seasons.

The processor-readable instructions which, when executed by the processing device, cause processing device to control a HVAC system, by the processing device preferably further cause the processing device to pause execution of the schedule when the thermostat is set to an away state. The readings from the one or more sensors are preferably recorded in the ledger for the current day.

These and other features and advantages of the invention will become more apparent with a description of preferred embodiments in reference to the associated drawings.

### DESCRIPTION OF THE DRAWINGS

FIG. 1 is a schematic representation of a thermostat connected to a plurality of sensors which is configured to control a HVAC (“Heating, Ventilation, and Air Conditioning”) system.

FIG. 2 is a schematic representation of Ledgers for the days of the week from Monday through Sunday as well as a history Ledger.

FIG. 3 is a schematic diagram of executable schedules S(D) in one or more embodiments

FIG. 4 is a flowchart showing an exemplary method for the Learning Engine of the programmable thermostat to learn users' schedule within one week in the initial learning period.

FIG. 5 is a flowchart showing an exemplary method for the changing user preferences based on changes made to the schedule on two consecutive days during the continuing learning period.

FIG. 6 is a flowchart showing an exemplary method for changing the user preferences based on changes made to the schedule on two consecutive weeks during the continuing learning period.

FIG. 7 is a flowchart of an exemplary method of making predictive adjustments.

FIG. 8 is a schematic, block diagram of a programmable thermostat in one or more embodiments.

FIG. 9 is a flowchart showing an exemplary method for programming a thermostat.

### BRIEF DESCRIPTION OF THE PREFERRED EMBODIMENTS

Many programmable thermostats allow users to manually enter a schedule for heating and cooling throughout a week. However, the schedules for users may vary over the course of a year, so a schedule that was previously entered may not provide the maximum energy savings.

In one or more embodiments, a programmable thermostat that automatically learns the users' schedule is contemplated. The programmable thermostat has a Learning Engine which monitors the users' real-time interaction with the thermostat over a course of a week during an initial learning period, and automatically generates a weekday and weekend schedule based on the users' actions. Once the thermostat has determined the users' schedule for the first week of use, the programmable thermostat will continue to monitor the users' actions during a continuing learning period and may alter the schedule as a result of change of usage. In one or more embodiments, the programmable thermostat is configured to make “predictive adjustments” to the thermostat set-points by considering the historical seasonal temperature variations, current outdoor temperature, and building thermal efficiency for heating and cooling.

As used herein and is commonly used in the art, the term “real-time” user entries refer user-entered thermostat settings that occur during and as part of the operation of the thermostat, where the user-entered thermostat settings take effect immediately upon entry. For example, if a user were to change the cooling set point of a thermostat to 78° F., the thermostat would immediately send control signals to the HVAC to reach the set point temperature of 78° F., and the thermostat would record the entry as a real-time user entry. This is in contrast with non-real-time user entries, in which the user-entries are to take effect on a later day or time from the time the user provides the entries.

The use of a HVAC (“Heating, Ventilation, and Air-Conditioning”) unit is described herein and is used for illustration purposes only. It shall be understood that HVAC system shall refer to equipment for controlling the temperature, humidity, and purity of air in an enclosed environment, and may refer to air-handling systems, heating systems, cooling systems, and air purification systems.

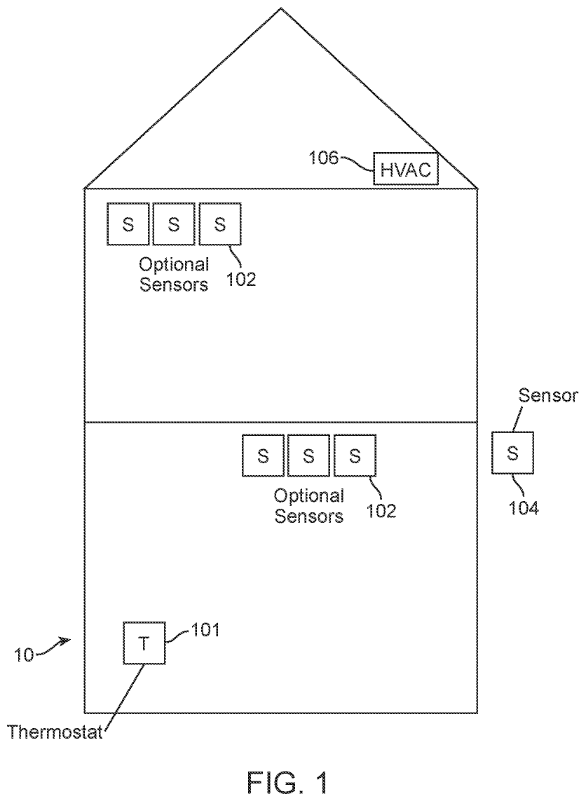

FIG. 1 is a schematic representation of an environment 10 having a programmable thermostat 101 which can automatically establish a schedule based on users' real-time actions. While examples discussed herein describe an environment 10 comprising a residential house, it shall be understood that this description is not limiting and that other environments 10 such as commercial buildings, industrial facilities, schools, and offices are contemplated in one or more embodiments. The programmable thermostat 101 controls an air handling system such as a heating, ventilation, and air conditioning (“HVAC”) system, and may interface with other sensors 102 placed throughout the environment as well as to exterior sensors 104 to the environment 10.

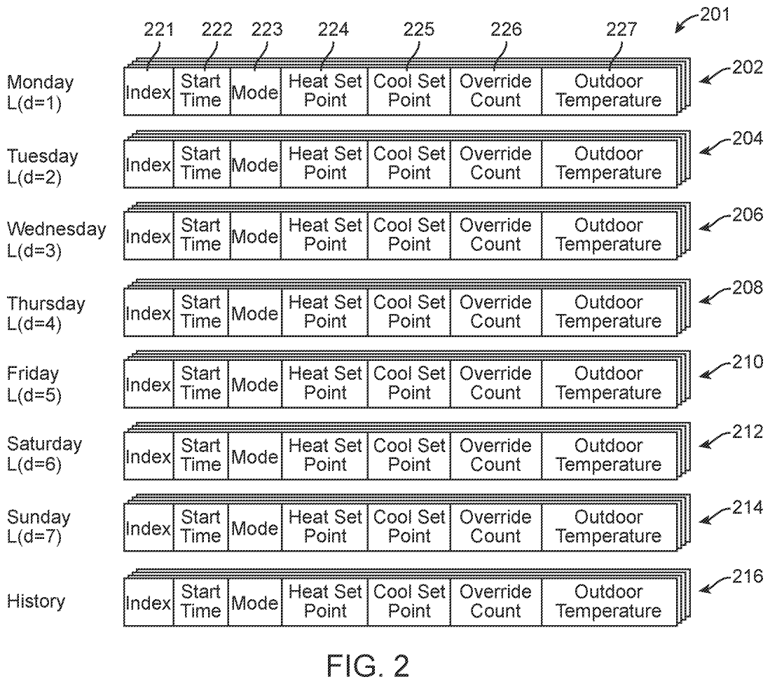

FIG. 2 presents a schematic diagram of ledger entries 201 which store users' actions such as changing the mode and/or set points. In an embodiment, the ledgers 201 comprise ledgers for Monday 202, Tuesday 204, Wednesday 206, Thursday 208, Friday 210, Saturday 212, Sunday 214, as well for a history 216. The separate history ledger 216 is kept to enhance the learning experience. In an embodiment, each ledger 202-216 contains the index 221, the Start Time 222, the mode 223, the heat set point 224, the cool set point 225, override count 226, and outdoor temperature 227. In an embodiment, each ledger 202-216 may contain additional entries for setting and controlling air-handling and purification systems.

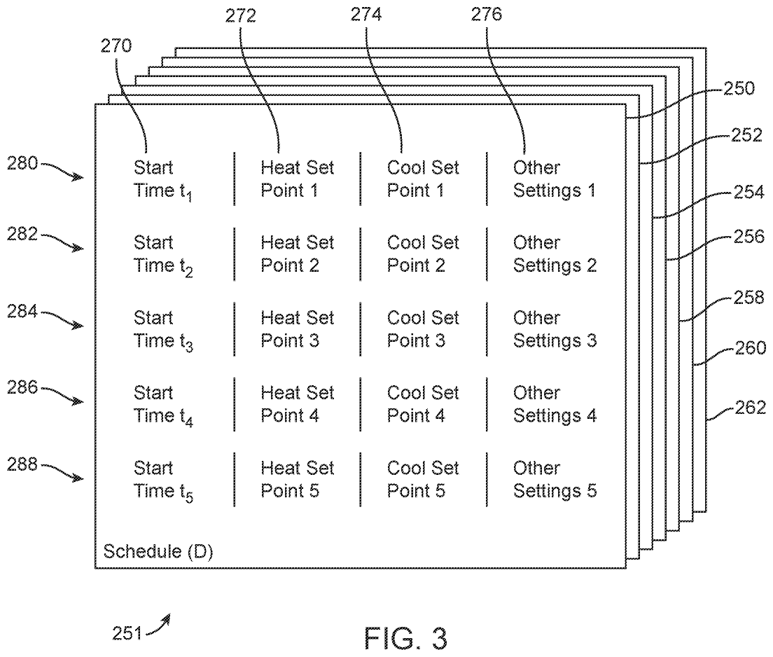

FIG. 3 is a schematic diagram of executable schedules S(D) 251 in one or more embodiments. Each schedule S(D) 250-262 comprise a series of recorded thermostat settings including heating set points 272, cooling set points 274, and other settings 276 as well as corresponding start times 270 for setting the thermostat 101 to the recorded thermostat settings. In one or more embodiments, the other settings 276 may be associated with enabling the blower fan, or may be associated with other HVAC functionality such as air filtration for example. Within each day of the week D, there may be several series of recorded thermostat settings to be employed (i.e., heat set point 272, cool set point 274, and other settings 276), starting with recorded instructions at time t₁ 280, time t₂ 282, time t₃ 284, time t₄ 286, and time t₅ 288 for example. Thermostat 101 will monitor the time, and when the time is equal to the first Start Time t₁, the thermostat 101 will execute the instructions to set the heating to Heat Set Point 1 272, cool set point 1 274, as well as other settings 1 276. When the time is equal to the second Start Time t₂, the thermostat 101 will execute the instructions to set the heating to Heat Set Point 2 272, cool set point 2 274, as well as other settings 2 276. This process continues for Start Time t₃, t₄, t₅, and other time periods within the schedule 250.

In an embodiment, multiple schedules S(D) 250-262 may be employed. For example, a first schedule 250 may be thermostats settings for use during weekdays (i.e., days of the week Monday through Friday) and the second schedule 252 may be for thermostat settings for a weekend (i.e., Saturday and Sunday). Where the user may have different thermostat preferences during a weekend, a separate schedule S(D) may be for Saturday 252, with another schedule 254 for Sunday. In an embodiment, multiple schedules S(D) are contemplated, including an embodiment in which a schedule S(D) is the schedule 250 for a Monday, schedule 252 for a Tuesday, schedule 254 for a Wednesday, schedule 256 for a Thursday, schedule 258 for a Friday, schedule 260 for a Saturday, and schedule 262 for a Sunday.

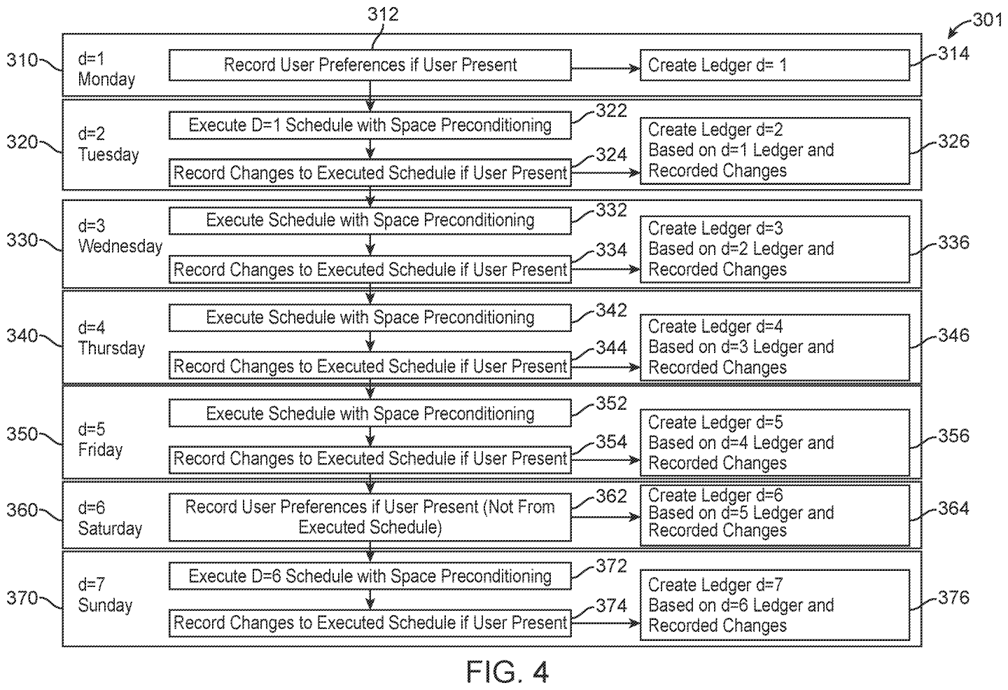

FIG. 4 is a flowchart showing an exemplary method 301 for the Learning Engine of the programmable thermostat 101 to learn users' schedule within one week during the initial learning period. In an embodiment, each day of the week has an action ledger that keeps track of user's mode and set point adjustments. Security limits are applied to the learned set points. Ledger entries are limited to maximum of 24 per day. Any ledger entry for the current hour will be rounded to the nearest entry. A separate history ledger will be kept to enhance the learning experience.

The thermostat schedule has 3 modes: off, on (manual), learning. Schedule and leaf icon, or appropriate text, displayed on the LCD indicates the learning schedule mode is activated. When schedule learning is activated, space preconditioning engine is also automatically turned on. The thermostat 101 will attempt to reach the set point temperature at the exact learned schedule time. If external sensors are connected, data from these sensors will aid the schedule learning. On non-touchscreen thermostats, button combination will turn on learning and will limit the mode button to cycling between available modes. Users can reset the learned schedule to factory defaults without resetting the thermostat datamap and start the schedule learning again. It will take a week to learn user's schedule.

In one or more embodiments, the Learning Engine follows two rules. First, the thermostats utilize mode and set point changes throughout the week to learn user's comfort settings. Geofencing has higher priority than the learned schedule and will pause schedule execution when thermostat is set to away state. Hence, the thermostat will record user preferences if the user is present.

Second, when schedule learning is activated, the space preconditioning engine is also automatically turned on. The thermostat will attempt to reach the set point temperature at the exact learned schedule time. Hence, the schedule is executed with space preconditioning.

As an example, during the initial learning period, the Learning Engine begins to learn the users' preferences on the first day, d=1, which is a Monday in this example. As used herein, lowercase “d” refers to the day which starts at d=1 (i.e., the first day) and continues indefinitely. Uppercase “D” refers to the day of the week having a range of 1-7, where D=1 refers to Monday, D=2 refers to Tuesday, and continues to D=7 for Sunday, for example. The Learning Engine will record the user preferences (step 312) and create a ledger 202 (see FIG. 2) for d=1 (step 314). When the user changes the mode and/or set points, thermostat makes a record of these settings to add to the learning ledger 202 and stores them in memory. The thermostat 101 will assume the adjustments made throughout the first day apply to the rest of the weekdays.

The thermostat will continue to change the learned schedule 250 throughout the first five days while keeping a list of timestamps, mode and set points on file so it can constantly compare the user settings to what it learned before. In an embodiment, the schedule 250 will comprise a “weekday” schedule which will accumulate the real-time, user-entered thermostat settings over the course of the five weekdays, and will, at first iteration, provide a weekday schedule which is identical for all weekdays. As discussed below with respect to the continuing learning algorithm, real-time, user entered changes for individual weekdays may result in individual schedules for each day of the weekdays.

On the second day, d=2, which is a Tuesday in this example, the Learning Engine will execute the d=1 weekday schedule with space preconditioning (step 322) and record changes to user preferences if user is present (step 324), and then create a ledger for d=2 204 (FIG. 2) based on d=1 ledger and recorded changes (step 326).

On the third day, d=3, which is a Wednesday, the Learning Engine will execute a schedule with space preconditioning (step 332) and record changes to user preferences if user is present (step 334), and then create a ledger for d=3 206 (FIG. 2) based on the executed weekday schedule 250 and recorded changes (step 336).

On the fourth day, d=4, which is a Thursday, the Learning Engine will execute a schedule with space preconditioning (step 342) and record changes to user preferences if user is present (step 344), and then create a ledger for d=4 208 (FIG. 2) based on the executed schedule 250 and recorded changes (step 346).

On the fifth day, d=5, which is a Friday, the Learning Engine will execute a schedule 250 with space preconditioning (step 352) and record changes to user preferences if user is present (step 354), and then create a ledger for d=5 210 (FIG. 2) based on the executed schedule 250 and recorded changes (step 356).

For most users, the weekend schedule will differ from the rest of the week. The first weekend day adjustments are assumed to initially apply to the second weekend day. The second weekend day adjustments will not apply to the first weekend day. On the sixth day, d=6, which is a Saturday, the Learning Engine will record the user preferences in a weekend schedule 252 (not from an executed weekday schedule) (step 362) and create a ledger for d=6 212 (FIG. 2) (step 364).

On the seventh day, d=7, which is a Sunday, the Learning Engine will execute a weekend schedule with space preconditioning (step 372) and record changes to user preferences if user is present (step 374), and then create a ledger for d=7 214 (FIG. 2) based on the executed weekend schedule 252 and recorded changes (step 376).

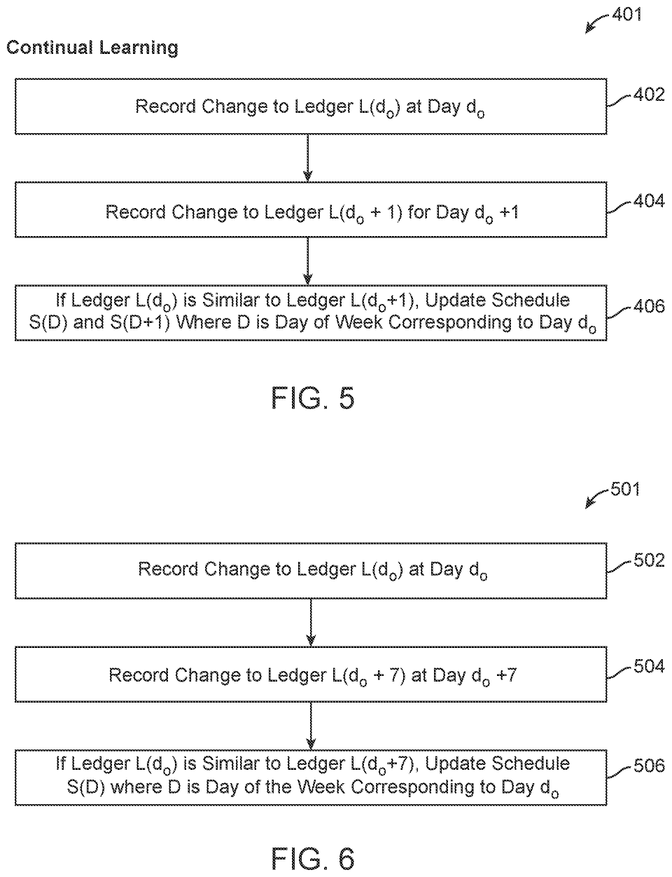

FIGS. 5 and 6 present a flowchart of exemplary methods for Continual Learning. As the initial learning period is completed after seven calendar days, the thermostat 101 does not adjust ledger entries for every small change after the seventh day. The thermostat will only record changes that are made in two consecutive days at about the same time or same changes on the same day in two consecutive weeks.

For example, for changes made on two consecutive days, say Tuesday and Wednesday for example, these changes are made during the same period and is learned for the whole weekdays. Likewise, the same changes to the thermostat settings that are made on Monday, and the next Monday, that day period will be learned. Also, same changes to the thermostat settings that are made on Saturday and Sunday during the same weekend, weekend day period is learned.

FIG. 5 is a flowchart showing an exemplary method 401 for the changing user preferences based on changes made to the schedule on two consecutive days. During the continuing learning period, the Learning Engine will record changes to user preference at day dₒ (step 402), record the change to user preference at D=dₒ+1 (step 404). If the changes to user preferences are similar or consistent for day dₒ and dₒ+1, the Engine will update the ledger for days of week corresponding to D=dₒ and D=dₒ+1 (step 406). Determining whether the user preferences are similar or consistent for two different days may comprise rounding ledger entries for the current hour to the nearest entry. Where the selected set point differs, an algorithm may be employed to select an updated set point based on an average value, a minimum value, or a maximum value of the set points.

FIG. 6 is a flowchart showing an exemplary method 501 for changing the user preferences based on changes made to the schedule on two consecutive weeks. The Learning Engine will record the changes to user preference at day dₒ (step 502), record the change to user preference at day dₒ+7 (step 504), and if the changes to the user preference is similar or consistent for day dₒ and day dₒ+7, update the ledger for day of the week corresponding to D=dₒ and D=dₒ+7 (step 506).

Predictive Adjustments is an additional smart algorithm that uses Machine Learning models trained across multiple embodiments of connected thermostats and predicts the user's comfort settings at the edge with inputs from historical seasonal temperature variations, current outdoor temperature from weather forecast or actual sensors, building thermal efficiency for heating and cooling, and equipment performance during different seasons. When Predictive Adjustments is active, thermostat will make temporary changes to the set points and the preconditioning start time without user intervention and augments the learned schedule.

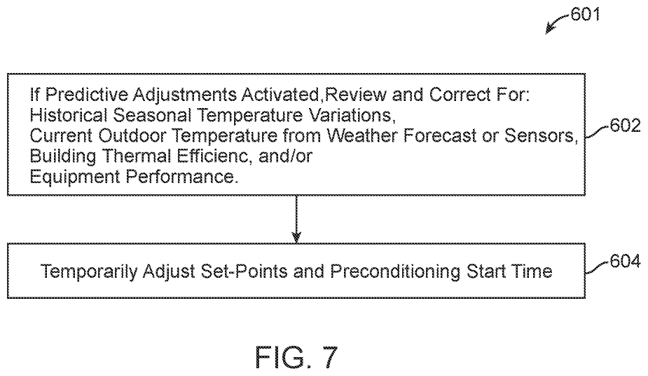

FIG. 7 is a flowchart of an exemplary method 601 of making predictive adjustments. If predictive adjustments activated, the thermostat 101 will review Historical Seasonal Temperature Variations, Current Outdoor Temperature from Weather Forecast or Sensors, Building Thermal Efficiency, and Equipment Performance (step 602). The thermostat will temporarily adjust set-points and preconditioning start time (step 604).

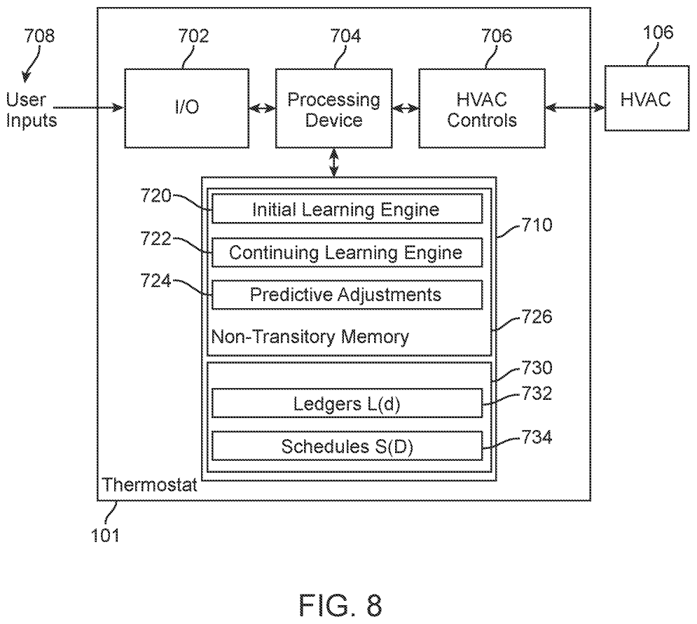

FIG. 8 is a schematic, block diagram of a programmable thermostat in one or more embodiments. In an embodiment, thermostat 101 comprises an Input/Output (“I/O”) circuit 702, a processing device 704, a HVAC control circuitry 706 for controlling a HVAC system 106 or similar air-handling system, and a memory 710. The user can interact with the thermostat 101 through the I/O circuit 702 via user inputs 706, which may include a touchscreen or individual buttons and a display for entering thermostat settings such as the heat set point, cooling set point, learning mode enabled, as well as other settings for a HVAC system.

The memory 710 comprises a non-transitory computer-readable medium 726 communicatively coupled to the processing device 704. The medium 726 has stored therein processor-readable instructions which, when executed by the processing device 704, cause processing device 704 to control a HVAC system 106. The non-transitory computer-readable medium 710 comprises algorithms for the Initial Learning Engine 720, algorithms for the Continuing Learning Engine 722, and algorithms for Predictive Adjustments 724.

The memory 710 also comprises a memory or database 730 which stores information of the ledgers L(d) 732 and schedule S(D) 734. As discussed above, the schedule 251 (FIG. 3) comprises a series of recorded thermostat settings 272, 274, 276 and corresponding start times 270 for setting the thermostat 101 to the recorded thermostat settings.

The processing device 704 is configured to receive a real-time, user-entered thermostat setting 708 for the current day. The processing device 704 is further configured to record the user-entered thermostat setting for the current day in a ledger 201 for the current day, the ledger for the current day comprising the user-entered thermostat setting for the current day and a corresponding timestamp indicating the time the user-entered thermostat setting was entered into the thermostat 101.

In response to the user-entered thermostat setting during an initial learning period, the processing device 704 is configured to modify the schedule 251 for the current day of the week during the initial learning period by imposing the user-entered thermostat setting and corresponding timestamp for the current day onto the schedule 251 for the current day of the week, the schedule 251 for the current day of the week based on the schedule for the immediately prior day of the week.

In response to the user-entered thermostat setting during the continuing learning period, the processing device 704 is further configured to modify the schedule 251 for the current day of the week during the continuing learning period is based on predetermined rules and a plurality of ledgers of previous days.

In an embodiment, the processing device 704 further performs predictive adjustments in which the processing device 705 provides temporary changes to the thermostat setpoints and start times to provide a period of preconditioning of the environment controlled by the thermostat. The processing device 704 may provide temporary changes to the thermostat setpoints and start times based on one or more of the following: historical seasonal temperature variations, current outdoor temperature, building thermal efficiency for heating and cooling, and equipment performance during different seasons. In an embodiment, the processing device 704 pauses execution of the schedule 251 when the thermostat 101 is set to an away state. In an embodiment, readings from the one or more sensors 102 and 104 (see FIG. 1) are recorded in the ledger for the current day.

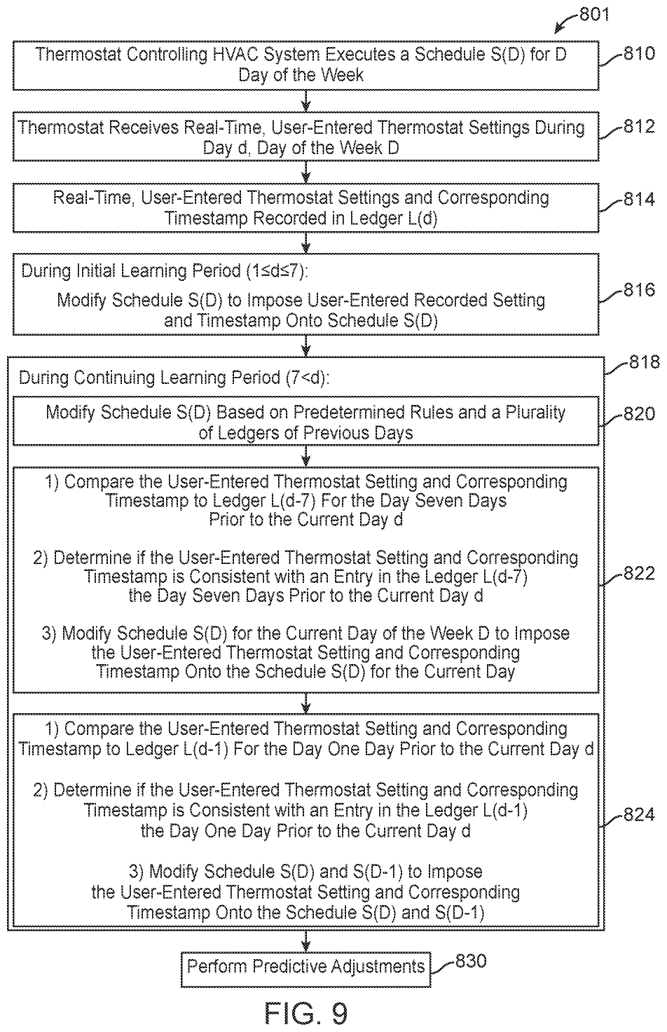

FIG. 9 is a flowchart 801 showing an exemplary method for programming a thermostat 101. The thermostat 101 controlling a HVAC System 106 executes a schedule S(D) 251 for D day of the week (step 810). The thermostat 101 receives real-time, user-entered thermostat settings during day d, which corresponds with the day of the week D (step 812). The real-time, user-entered thermostat settings 223-227 and corresponding timestamp 222 are recorded in the ledger L(d) 201 (step 814).

During the initial learning period, where the day is in the range from the first day to the seventh day (1≤d≤7), the schedule S(D) is modified to impose user-entered recorded setting and timestamp onto the schedule S(D) 251 (step 816).

During the continuing learning period, where the day is in the range greater than day seven (7<d), the schedule S(D) is modified based on predetermined rules and a plurality of ledgers of previous days (steps 818 and 820). In an embodiment, the processing device 704 (1) compares the user-entered thermostat setting and corresponding timestamp to Ledger L(d−7) for the day seven days prior to the current day d, (2) determines if the user-entered thermostat setting and corresponding timestamp is consistent with an entry in the Ledger L(d−7) the day seven days prior to the current day d, and (3) modifies Schedule S(D) for the current day of the week D to impose the user-entered thermostat setting and corresponding timestamp onto the Schedule S(D) for the current day (Step 822)

In an embodiment, the processing device 704 (1) compares the user-entered thermostat setting and corresponding timestamp to Ledger L(d−1) for the day one day prior to the current day d, (2) determines if the user-entered thermostat setting and corresponding timestamp is consistent with an entry in the Ledger L(d−1) the day one day prior to the current day d, and (3) modifies the Schedule S(D) for the current day of the week D to impose the user-entered thermostat setting and corresponding timestamp onto the Schedule S(D) for the current day (step 824).

In an embodiment, the processing device 704 will perform “predictive adjustments” where the processing device 704 provides temporary changes to the thermostat setpoints and start times to provide a period of preconditioning of the environment controlled by the thermostat (step 830). The temporary changes to the thermostat setpoints and start times may be based on one or more of the following: historical seasonal temperature variations, current outdoor temperature, building thermal efficiency for heating and cooling, and equipment performance during different seasons.

In an embodiment, the thermostat 101 is configured to pause execution of the schedule when the thermostat 101 is set to an away state. The thermostat 101 is configured to communicate with one or more sensors, where the readings from the one or more sensors are recorded in the ledger 201 for the current day.

In an embodiment, the schedule 251 for the current day of the week during the initial learning period comprises a weekday schedule and a weekend schedule. The initial learning period preferably comprises seven calendar days. In an embodiment, updating the weekend schedule on Sunday during the initial learning period does not update the weekend schedule for Saturday. The schedule 251 for the current day of the week comprises a weekday schedule comprising schedules for the days of the week of Monday, Tuesday, Wednesday, Thursday, and Friday and a weekend schedule comprising schedules for the days of the week for Saturday and Sunday.

Although the invention has been discussed with reference to specific embodiments, it is apparent and should be understood that the concept can be otherwise embodied to achieve the advantages discussed. The preferred embodiments above have been described primarily as a programmable thermostat having a Learning Engine. In this regard, the foregoing description is presented for purposes of illustration and description. Furthermore, the description is not intended to limit the invention to the form disclosed herein. Accordingly, variants and modifications consistent with the following teachings, skill, and knowledge of the relevant art, are within the scope of the present invention. The embodiments described herein are further intended to explain modes known for practicing the invention disclosed herewith and to enable others skilled in the art to utilize the invention in equivalent, or alternative embodiments and with various modifications considered necessary by the particular application(s) or use(s) of the present invention.

Unless specifically stated otherwise, it shall be understood that disclosure employing the terms “controlling,” “recording,” “modifying,” “coupling,” “receiving,” “communicating,” “computing,” “determining,” “calculating,” and others refer to a data processing system or other electronic device manipulating or transforming data within the device memories or controllers into other data within the system memories or registers. When applicable, the ordering of the various steps described herein may be changed, combined into composite steps, or separated into sub-steps to provide the features described herein.

Computer programs such as a program, software, software application, code, or script may be written in any computer programming language including conventional technologies, object-oriented technologies, interpreted or compiled languages, and can be a module, component, or function. Computer programs may be executed in one or more processors or computer systems.

What is claimed is:

1. A method for programming a thermostat based on a history of real-time, user-entered thermostat settings, the method comprising:
controlling a HVAC system, by a thermostat configured to execute a schedule for a current day of the week, the schedule comprising a series of recorded thermostat settings including heating set points, cooling set points, and other thermostat settings as well as corresponding start times for setting the thermostat to the recorded thermostat settings;
receiving a real-time, user-entered thermostat setting for the current day;
recording the real-time, user-entered thermostat setting for the current day in a ledger for the current day, the ledger for the current day comprising the user-entered thermostat setting for the current day and a corresponding timestamp indicating the time the user-entered thermostat setting was entered into the thermostat;
in response to the real-time, user-entered thermostat setting during an initial learning period, modifying the schedule for the current day of the week during the initial learning period by imposing the user-entered thermostat setting and corresponding timestamp for the current day onto the schedule for the current day of the week, the schedule for the current day of the week based on the schedule for the immediately prior day of the week, wherein the schedule for the current day of the week during the initial learning period comprises a weekday schedule and a weekend schedule;
in response to the real-time, user-entered thermostat setting during the continuing learning period, the continuing learning period occurs subsequent to the completion of the initial learning period, modifying the schedule for the current day of the week during the continuing learning period is based on predetermined rules and a plurality of ledgers of previous days,
wherein modifying the schedule for the current day of the week during the continuing learning period for the current day comprises
comparing the user-entered thermostat setting and corresponding timestamp to the ledger for the day seven days prior to the current day,
determining if the user-entered thermostat setting and corresponding timestamp is consistent with an entry in the ledger for the day seven days prior to the current day, and,
modifying the schedule for the current day of the week during the continuing learning period to impose the user-entered thermostat setting and corresponding timestamp onto the schedule for the current day; and,
wherein modifying the schedule for the current day of the week during the continuing learning period for the current day comprises
comparing the user-entered thermostat setting and corresponding timestamp to the ledger for the day one day prior to the current day,
determining if the user-entered thermostat setting and corresponding timestamp is consistent with an entry in the ledger for the day one day prior to the current day, and,
modifying the schedule for the current day of the week during the continuing learning period to impose the user-entered thermostat setting and corresponding timestamp onto the schedule for the current day and the schedule for the day one day prior to the current day of the week.

2. The method for programming a thermostat based on a history of real-time, user-entered thermostat settings of claim 1, wherein controlling a thermostat configured to execute a schedule for a current day of the week further comprises providing temporary changes to the thermostat setpoints and start times to provide a period of preconditioning of the environment controlled by the thermostat.

3. The method for programming a thermostat based on a history of real-time, user-entered thermostat settings of claim 1, wherein controlling a thermostat configured to execute a schedule for a current day of the week further comprises providing temporary changes to the thermostat setpoints and start times based on one or more of the following: historical seasonal temperature variations, current outdoor temperature, building thermal efficiency for heating and cooling, and equipment performance during different seasons.

4. The method for programming a thermostat based on a history of real-time, user-entered thermostat settings of claim 1, wherein controlling a HVAC system, by a thermostat further comprises the thermostat configured to pause execution of the schedule when the thermostat is set to an away state.

5. The method for programming a thermostat based on a history of real-time, user-entered thermostat settings of claim 1, wherein the thermostat is configured to communicate with one or more sensors, wherein the readings from the one or more sensors are recorded in the ledger for the current day.

6. A method for programming a thermostat based on a history of real-time, user-entered thermostat settings, the method comprising:
controlling a HVAC system, by a thermostat configured to execute a schedule for a current day of the week, the schedule comprising a series of recorded thermostat settings and corresponding start times for setting the thermostat to the recorded thermostat settings;
receiving a real-time, user-entered thermostat setting for the current day;
recording the real-time, user-entered thermostat setting for the current day in a ledger for the current day, the ledger for the current day comprising the user-entered thermostat setting for the current day and a corresponding timestamp indicating the time the user-entered thermostat setting was entered into the thermostat;
in response to the real-time, user-entered thermostat setting during an initial learning period, modifying the schedule for the current day of the week during the initial learning period by imposing the user-entered thermostat setting and corresponding timestamp for the current day onto the schedule for the current day of the week, the schedule for the current day of the week based on the schedule for the immediately prior day of the week;
in response to the user-entered thermostat setting during the continuing learning period, modifying the schedule for the current day of the week during the continuing learning period is based on predetermined rules and a plurality of ledgers of previous days.

7. The method for programming a thermostat based on a history of real-time, user-entered thermostat settings of claim 6, wherein the continuing learning period occurs subsequent to the completion of the initial learning period.

8. The method for programming a thermostat based on a history of real-time, user-entered thermostat settings of claim 6, wherein controlling a HVAC system, by a thermostat further comprises the thermostat configured to pause execution of the schedule when the thermostat is set to an away state.

9. The method for programming a thermostat based on a history of real-time, user-entered thermostat settings of claim 6, wherein the thermostat is configured to communicate with one or more sensors, wherein the readings from the one or more sensors are recorded in the ledger for the current day.

10. The method for programming a thermostat based on a history of real-time, user-entered thermostat settings of claim 6, wherein the schedule for the current day of the week during the initial learning period comprises a weekday schedule and a weekend schedule.

11. The method for programming a thermostat based on a history of real-time, user-entered thermostat settings of claim 6, wherein the initial learning period comprises seven calendar days.

12. The method for programming a thermostat based on a history of real-time, user-entered thermostat settings of claim 6, wherein updating the weekend schedule on Sunday during the initial learning period does not update the weekend schedule for Saturday.

13. The method for programming a thermostat based on a history of real-time, user-entered thermostat settings of claim 6, wherein the schedule for the current day of the week comprises a weekday schedule comprising schedules for the days of the week of Monday, Tuesday, Wednesday, Thursday, and Friday and a weekend schedule comprising schedules for the days of the week for Saturday and Sunday.

14. The method for programming a thermostat based on a history of real-time, user-entered thermostat settings of claim 6, wherein modifying the schedule for the current day of the week during the continuing learning period for the current day further comprises:
comparing the user-entered thermostat setting and corresponding timestamp to the ledger for the day seven days prior to the current day,
determining if the user-entered thermostat setting and corresponding timestamp is consistent with an entry in the ledger for the day seven days prior to the current day, and
modifying the schedule for the current day of the week during the continuing learning period to impose the user-entered thermostat setting and corresponding timestamp onto the schedule for the current day.

15. The method for programming a thermostat based on a history of real-time, user-entered thermostat settings of claim 6, wherein modifying the schedule for the current day of the week during the continuing learning period for the current day further comprises:
comparing the user-entered thermostat setting and corresponding timestamp to the ledger for the day one day prior to the current day,
determining if the user-entered thermostat setting and corresponding timestamp is consistent with an entry in the ledger for the day one day prior to the current day, and
modifying the schedule for the current day of the week during the continuing learning period to impose the user-entered thermostat setting and corresponding timestamp onto the schedule for the current day and the schedule for the day one day prior to the current day of the week.

16. A programmable thermostat comprising:
a processing device; and,
a non-transitory computer-readable medium communicatively coupled to the processing device, the medium having stored therein processor-readable instructions which, when executed by the processing device, cause processing device to:
control a HVAC system, by the processing device configured to execute a schedule for a current day of the week, the schedule comprising a series of recorded thermostat settings and corresponding start times for setting the thermostat to the recorded thermostat settings;
receive a real-time, user-entered thermostat setting for the current day;
record the user-entered thermostat setting for the current day in a ledger for the current day, the ledger for the current day comprising the user-entered thermostat setting for the current day and a corresponding timestamp indicating the time the user-entered thermostat setting was entered into the thermostat;
in response to the user-entered thermostat setting during an initial learning period, modify the schedule for the current day of the week during the initial learning period by imposing the user-entered thermostat setting and corresponding timestamp for the current day onto the schedule for the current day of the week, the schedule for the current day of the week based on the schedule for the immediately prior day of the week;
in response to the user-entered thermostat setting during the continuing learning period, modify the schedule for the current day of the week during the continuing learning period is based on predetermined rules and a plurality of ledgers of previous days.

17. The programmable thermostat of claim 16, wherein the processor-readable instructions which, when executed by the processing device, further cause the processing device to provide temporary changes to the thermostat setpoints and start times to provide a period of preconditioning of the environment controlled by the thermostat.

18. The programmable thermostat of claim 16, the processor-readable instructions which, when executed by the processing device, further cause the processing device to provide temporary changes to the thermostat setpoints and start times based on one or more of the following: historical seasonal temperature variations, current outdoor temperature, building thermal efficiency for heating and cooling, and equipment performance during different seasons.

19. The programmable thermostat of claim 16, the processor-readable instructions which, when executed by the processing device, further cause the processing device to pause execution of the schedule when the thermostat is set to an away state.

20. The programmable thermostat of claim 16, wherein the thermostat is configured to communicate with one or more sensors, wherein the readings from the one or more sensors are recorded in the ledger for the current day.
